(19) United States
(12) Patent Application Publication
(10) Pub. No.: US 2011/0018786 A1
(43) Pub. Date: Jan. 27, 2011

(54) PLASMA DISPLAY PANEL AND PLASMA DISPLAY DEVICE

(76) Inventors: Keiichi Betsui, Yokohama (JP); Tomonari Misawa, Yokohama (JP); Tadayoshi Kosaka, Yokohama (JP); Yoshiho Seo, Yokohama (JP); Hajime Inoue, Yokohama (JP); Shinya Fukuta, Yokohama (JP); Minoru Hasegawa, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/863,616

(22) PCT Filed: Apr. 7, 2008
(86) PCT No.: PCT/JP2008/056858

§ 371 Date: Oct. 7, 2010

(51) Int. Cl. G09G 3/28

(52) U.S. Cl. 345/60

(57) ABSTRACT

There is provided a technique for discharge stabilization of a plasma display panel by forming magnesium oxide with a large diameter and adjusting residual amounts of impurities contained in the magnesium oxide. That is, discharge stabilization material particle, which is coated on a protective-film layer of protecting electrodes and supplies sufficient amount of priming particles into a discharge gap, is focused. By setting each impurity concentration in the magnesium oxide used as the discharge stabilization material particle to 20 ppm or lower, discharge time lag is suppressed.

### TECHNICAL FIELD

The present invention relates to discharge stabilization of a plasma display, and more particularly, the present invention relates to priming-particle emission.

### BACKGROUND ART

In a plasma display panel, discharge stabilization is an important technique. For achieving the discharge stabilization, a structure and a material of starting the discharge at a low voltage and providing sufficient amount of priming particles are necessary.

For the structure and the material, it is proposed to form a deposited film made of magnesium oxide on a surface to which the discharge is applied, and crystalline of magnesium oxide is used for the priming-supplying material.

More particularly, in a technique of using the crystalline of magnesium oxide for the priming-supplying material, it is required to maintain the emission of priming particles (electrons) from the crystalline of magnesium oxide for sufficient long time (at least 16.6 mmsec corresponding to a display period for one frame, or longer).

Japanese Patent Application Laid-Open Publication No. 2006-147417 (Patent Document 1) discloses to provide a crystalline magnesium oxide layer containing crystalline powder having particle-size distribution in which a ratio of crystalline with a predetermined or larger particle diameter is equal to a predetermined value or higher, of the magnesium oxide crystalline powder emitting cathodoluminescence.

### DISCLOSURE OF THE INVENTION

### Problems to be Solved by the Invention

By studying crystal parameters for maintaining the emission of the priming particles over the time of 16.6 mmsec or longer in detail, it is found out that strong relation exists between the time of the emission of the priming particles and an average particle diameter of the particles.

In addition, the present inventors have found out that the maintaining time of the emission of the priming particles is significantly extended by decreasing aluminum concentration or others which is an impurity in the magnesium oxide of the discharge stabilization material particle to be coated on the deposited film (protective-film layer) made of magnesium oxide and on the protective-film layer.

A preferred aim of the present invention is to provide a technique for discharge stabilization of a plasma display panel by increasing a particle diameter of magnesium oxide and adjusting a remained amount of an impurity in the magnesium oxide.

The above and other preferred aims and novel characteristics of the present invention will be apparent from the description of the present specification and the accompanying drawings.

### Means for Solving the Problems

The typical ones of the inventions disclosed in the present application will be briefly described as follows.

A plasma display panel according to the typical embodiment of the present invention includes a glass-plate module including: a glass plate; a dielectric layer contacting with the glass plate; and a protective-film layer of protecting the dielectric layer. In the plasma display panel, magnesium oxide whose BET specific surface area is 3 m²/mg or smaller is used as a discharge stabilization material particle coated on the protective-film layer.

Another plasma display panel according to the typical embodiment of the present invention includes a glass-plate module including: a glass plate; a dielectric layer contacting with the glass plate; and a protective-film layer of protecting the dielectric layer. In the plasma display panel, magnesium oxide whose impurity content is 20 ppm or lower is used as the discharge stabilization material particle coated on the protective-film layer.

The impurity of the magnesium oxide may be aluminum, iron, nickel, manganese, or chromium.

A plasma display panel according to the typical embodiment of the present invention includes a glass-plate module including: a glass plate; a dielectric layer contacting with the glass plate; and a protective-film layer of protecting the dielectric layer. In the plasma display panel, magnesium oxide containing impurities in which all or a part of aluminum, iron, nickel, manganese, and chromium are mixed is used as the discharge stabilization material particle coated on the protective-film layer, and each content of aluminum, iron, nickel, manganese, and chromium in the magnesium oxide is 20 ppm or lower.

In these plasma display panels, magnesium oxide, calcium oxide, strontium oxide, barium oxide, or these composite oxide may be used as a material of the protective-film layer.

### EFFECTS OF THE INVENTION

The effects obtained by typical aspects of the present invention will be briefly described below.

In the plasma display panel according to the typical embodiment of the present invention, good priming effect can be maintained for long time of one frame or longer by using magnesium oxide single crystal particle, whose particle diameter is large and impurity content is low, for a discharge stabilization material particle as a priming-supplying material.

### BRIEF DESCRIPTIONS OF THE DRAWINGS

FIG. 1 is a perspective cross-sectional view illustrating a structure of a module on a front-surface glass plate side of a plasma display panel supposed in a first embodiment;

FIG. 2 is a perspective cross-sectional view of a plasma display panel 100 using the module on the front-surface glass plate side in FIG. 1;

FIG. 3 is a graph illustrating a relation between discharge time lag and an aluminum concentration which is one of impurities contained in magnesium oxide powder;

FIG. 4 is a graph illustrating a relation between discharge time lag and an iron concentration which is one of impurities contained in magnesium oxide powder;

FIG. 5 is a graph illustrating a relation between discharge time lag and a nickel concentration which is one of impurities contained in magnesium oxide powder;

FIG. 6 is a graph illustrating a relation between discharge time lag and a manganese concentration which is one of impurities contained in magnesium oxide powder;

FIG. 7 is a graph illustrating a relation between discharge time lag and a chromium concentration which is one of impurities contained in magnesium oxide powder;

FIG. 8 is a graph illustrating particle-size distribution of magnesium oxide powder having two different types of particle diameters used in a second embodiment; and

FIG. 9 is a graph illustrating a relation between discharge time lag and the interval time in a state that a certain amount of the magnesium oxide powder having two different types of particle diameters used in the second embodiment is spread on a surface of a protective-film layer as a discharge stabilization material particle.

### BEST MODE FOR CARRYING OUT THE INVENTION

Hereinafter, embodiments of the present invention are described with reference to figures.

### First Embodiment

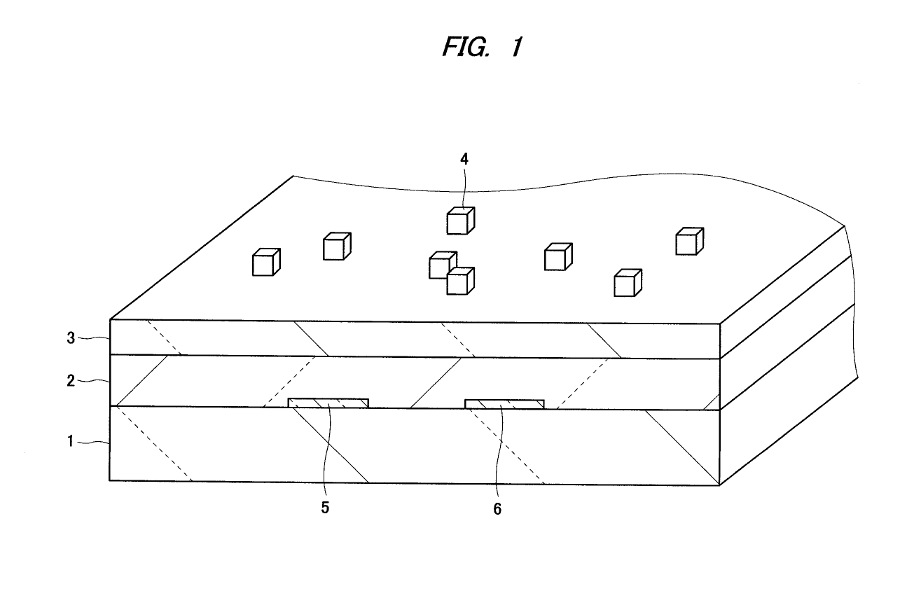

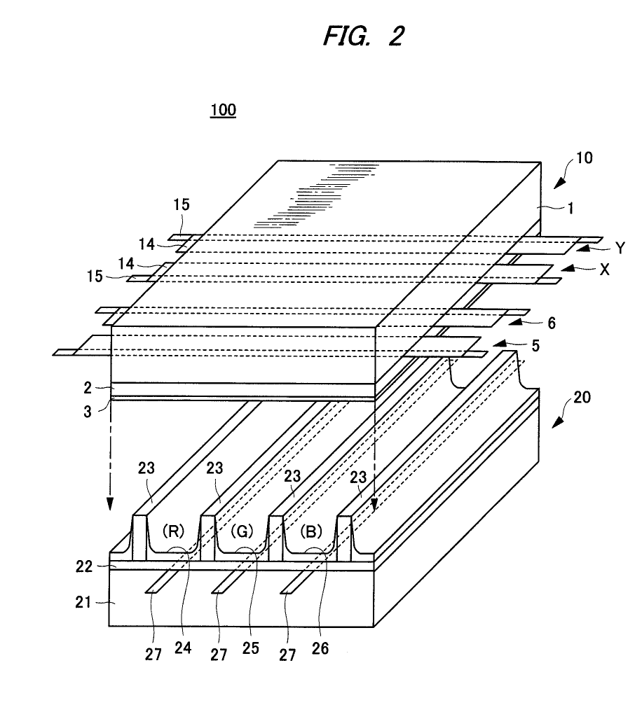

FIG. 1 is a perspective cross-sectional view illustrating a structure of a module 10 on a front-surface glass plate side of a plasma display panel supposed in a first embodiment of the present invention. Also, FIG. 2 is a perspective cross-sectional view of a plasma display panel 100 using the module 10 on the front-surface glass plate side.

The module 10 on the front-surface glass plate side includes: a front-surface glass plate 1; a dielectric layer 2; a protective-film layer 3; discharge stabilization material particles 4; X electrodes 5; and Y electrodes 6.

The front-surface glass plate 1 is a glass plate used for sealing components of the plasma display panel between itself and a rear-surface glass plate not illustrated in FIG. 1 (rear-surface glass plate 21 in FIG. 2).

The dielectric layer 2 is a transparent dielectric layer coated on the front-surface glass plate 1. After forming the X electrodes 5 and the Y electrodes 6, it is formed of a glass layer having a low melting point and a thickness of 20 micrometer.

The protective-film layer 3 is an insulating protective film for preventing damage of the dielectric layer 2 due to discharge phenomenon. It is formed of a layer made of a protective-film material (such as magnesium oxide, strontium oxide, calcium oxide, and barium oxide) and having a thickness of 1 micrometer by a vacuum deposition method.

The discharge stabilization material particles 4 supply priming particles and emit luminescence. After forming the protective-film layer 3, it is formed by spreading magnesium oxide powder on the protective film as the discharge stabilization material.

The X electrode 5 and the Y electrode 6 are transparent electrodes for plasma discharge of rare gas such as xenon, filled between the front-surface glass plate 1 and the rear-surface glass plate, by applying voltage between the X electrode 5 and the Y electrode 6 after preliminary discharge performed by address electrodes (address electrodes 27 in FIG. 2) provided on the rear-surface glass plate not illustrated in FIG. 1. Each of these electrodes includes a transparent electrode 14 and a bus electrode 15. The discharge caused by the plasma excites a phosphor (any one of red phosphor 24, green phosphor 25, and blue phosphor 26) and emits its light.

Each of these X electrode 5 and Y electrode 6 is formed of ITO and Cr/Cu/Cr on the front-surface glass plate 1.

The plasma display panel 100 using the module 10 on the front-surface glass plate side includes: the module 10 on the front-surface glass plate side; and a module 20 on the rear-surface glass plate side.

The module 20 on the rear-surface glass plate side includes: a rear-surface glass plate 21; a base layer 22; ribs 23; the red phosphor 24; the green phosphor 25; the blue phosphor 26; and the address electrodes 27.

The rear-surface glass plate 21 is a glass plate used for sealing components of the plasma display panel between itself and the front-surface glass plate 1.

The base layer 22 is a dielectric layer for protecting the address electrodes 27 in a structure of the ribs 23 or others.

The ribs 23 are partition walls for independently causing the plasma discharge in each cell unit. A discharge gas is filled into a space (discharge gap) partitioned by the ribs, the module 10 on the front-surface glass plate side, and the rear-surface glass plate 21.

The red phosphor 24 is a phosphor excited by plasma generated by applying a voltage to the X electrodes 5, the Y electrodes 6, and the address electrodes 27, and emitting red color. Mainly, an yttrium-based chemical compound is used for the phosphor.

The green phosphor 25 is a phosphor excited by ultra violet rays in plasma, and emitting green color. A green-silicate-based phosphor is used for the green phosphor 25.

The blue phosphor 26 is a phosphor excited by ultra violet rays in plasma and emitting blue color. A blue-aluminate-based phosphor is used for the blue phosphor 26.

The address electrodes 27 are electrodes for the preliminary discharge for the plasma discharge.

These module 10 on the front-surface glass plate side and module 20 on the rear-surface glass plate side are attached to each other, and a periphery of them is sealed by a glass having a low melting point. After the sealing, an inside of the panel is exhausted to vacuum for degassing process with rise in temperature.

And then, discharge gas (xenon 10%+neon 90%) is filled inside the panel.

In the foregoing, a basic structure of the plasma display panel is described, and various data shown in the present specification is also measured in the basic structure of the plasma display as illustrated in FIGS. 1 and 2. In the present embodiment, the discharge stabilization material particle 4 is described.

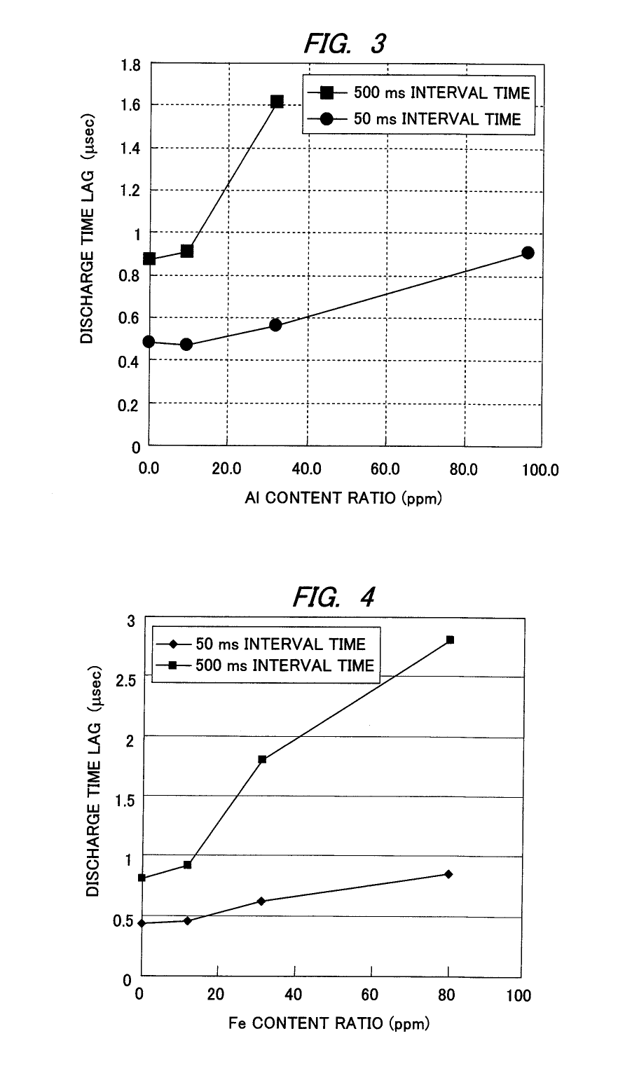

FIG. 3 is a graph illustrating a relation between discharge time lag and an aluminum concentration which is one of impurities contained in the magnesium oxide powder.

A horizontal axis of the graph shows a content ratio of the aluminum impurity contained in the magnesium oxide powder. A unit in the axis is “PPM”. On the other hand, a vertical axis of the same shows static discharge time lag, and a unit in the axis is “μ (micro) sec”.

As seen from the figure, when an interval time (maintaining time) is 50 msec, dependency of the concentration for the discharge time lag is low. On the other hand, when the interval time is long, a concentration of the priming particles in the discharge gas is decreased, and therefore, the retention time of supplying the priming particles is clearly longer in a lower aluminum concentration (less impurity). This drastic change is caused in the aluminum content ratio of 20 ppm.

FIG. 4 is a graph illustrating a relation between the discharge time lag and an iron concentration which is one of impurities contained in magnesium oxide powder. A horizontal axis of the graph also shows a content ratio (ppm) of the iron impurity contained in the magnesium oxide powder, and a vertical axis of the same also shows static discharge time lag (μsec).

It is found out that, even when the impurity is iron, influences of the impurity to the discharge time lag are larger as the interval time is longer, and influences to the discharge time lag become large when the content ratio is over 20 ppm.

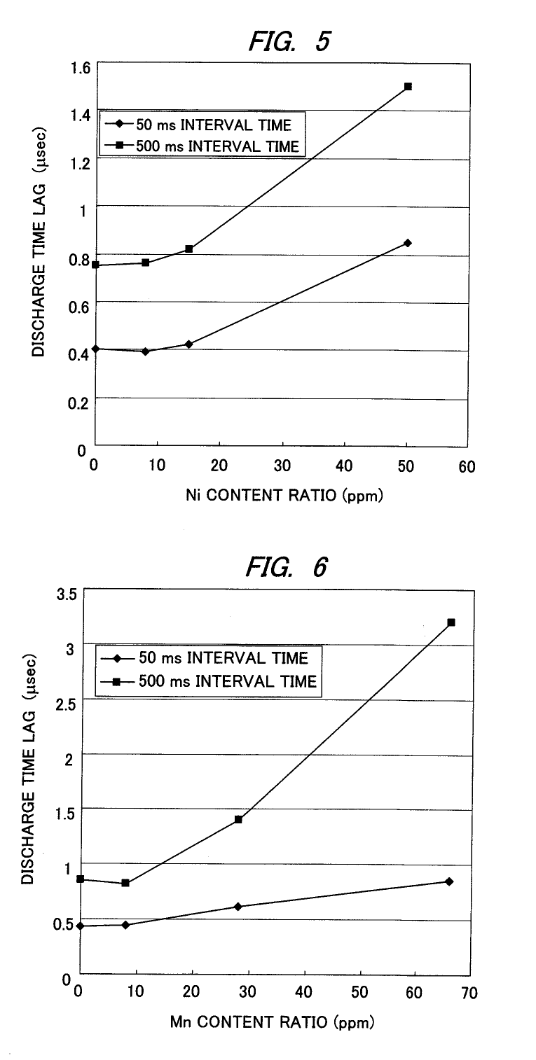

FIG. 5 is a graph illustrating a relation between the discharge time lag and a nickel concentration which is one of impurities contained in magnesium oxide powder. FIG. 6 is a graph illustrating a relation between discharge time lag and a manganese concentration which is one of impurities contained in magnesium oxide powder. Although slope changes even in nickel and manganese are gentle, discharge time lag changes are appeared in their content ratios of 20 ppm.

Therefore, it is preferred to set each content ratio of these impurities in the magnesium oxide powder to 20 ppm or lower.

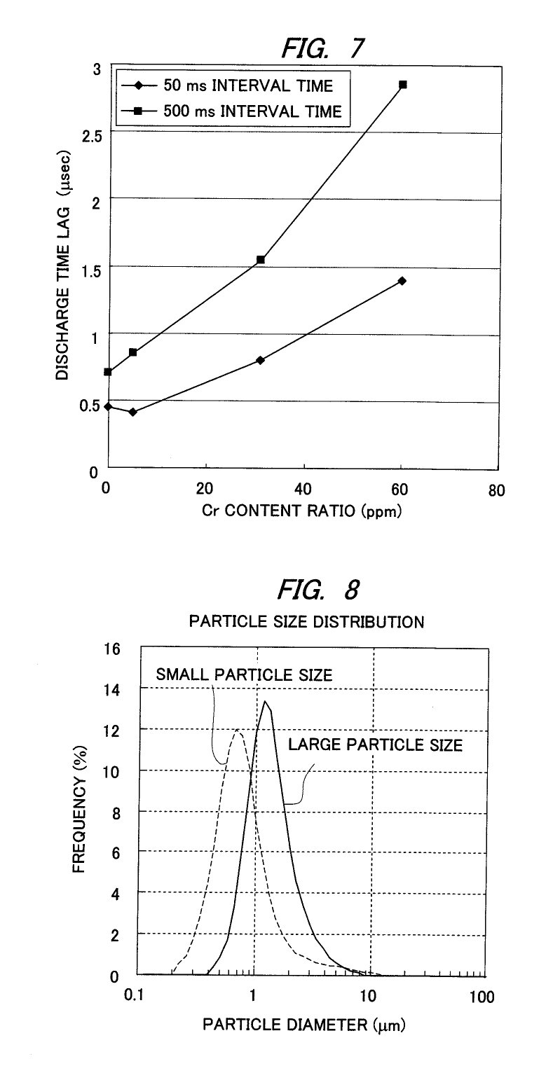

Meanwhile, FIG. 7 is a graph illustrating a relation between discharge time lag and a chromium concentration which is one of impurities contained in the magnesium oxide powder. In the case of chromium, a slope of the graph is changed at a previous measurement point of a content ratio of 40 ppm. However, a numerical item which is practically important for the discharge time lag of the plasma display panel is 1 μsec. In consideration of a region of this 1 μsec or shorter, it is preferred to set the content ratio to 20 ppm or lower, which is the same as those of other impurities described above.

When the magnesium oxide powder is practically used, it is considered that these materials are mixed into the powder in manufacture and distribution processes. However, even when they are mixed, it is only required to provide 20 ppm or lower in each content ratio.

As described above, by setting the concentration of each type of the impurities in the magnesium oxide powder used for the discharge stabilization material particle 4 to 20 ppm or lower, the discharge time lag can be suppressed.

### Second Embodiment

Next, a second embodiment of the present invention is described. In the present embodiment, difference of the discharge time lag depending on difference of the particle size is described.

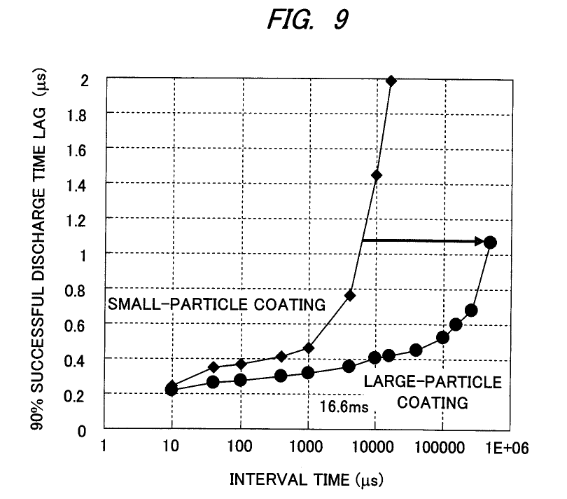

FIG. 8 is a graph illustrating particle-size distribution of the magnesium oxide powder having two different types of particle diameters such as “small particle size” and “large particle size” used in the present embodiment. Also, FIG. 9 is a graph illustrating a relation between the discharge time lag and the interval time in a state that a certain amount of these powders is spread on a surface of a protective-film layer as the discharge stabilization material particle 4.

The magnesium oxide powder used in measuring the “small particle size” in these figures is a vapor-phase synthesis MgO (product of 2000A particle diameter) produced by Ube Material Industries. This product has characteristics as follows.

BET surface area: 8 m²/mg

BET particle diameter: 2793 Å

arithmetic-mean diameter: 0.9254 (μm)

arithmetic standard deviation: 0.970 (μm)

mode diameter: 0.6267 (μm)

geometric-mean diameter: 0.7321 (μm)

On the other hand, as the magnesium oxide powder used in measuring the “large particle size”, the particle diameter of the product having the “small particle size” described above is increased by solid phase synthesis, and it is used. Its characteristics are as follows.

BET surface area: 2.4 m²/mg

BET particle diameter: 8950 Å

arithmetic-mean diameter: 1.4202 (μm)

arithmetic standard deviation: 0.8222 (μm)

mode diameter: 1.0812 (μm)

geometric-mean diameter: 1.2587 (μm)

Note that it is impossible to correctly uniform the characteristics of individual powder in practice, and therefore, variation is caused in practice. The variation is as illustrated in FIG. 8.

Next, the maintaining time of the discharge time lag when these two types of magnesium oxide powder are coated on the surface of the protective film is described with reference to FIG. 9.

A horizontal axis of FIG. 9 illustrates the interval time until re-discharge starts. On the other hand, a vertical axis of the same illustrates 90% successful discharge time lag that cumulative probability of successful discharge after applying voltage pulses becomes 90%. Units of both of the horizontal and vertical axes are “μsec”.

Regardless of the particle diameter, the longer the interval time until the re-discharge starts is, the larger the discharge time lag is. This is because the amount of the priming particles in the discharge gap is decreased by the long interval time.

When the powder of the “small particle size” is used for the discharge stabilization material particle 4, the discharge time lag is significantly increased in 1 msec or longer. On the other hand, when the powder of the “large particle size” is used for the discharge stabilization material particle 4, the discharge time lag is maintained at 1 μsec until the interval time is 100 msec (100000 μsec) or longer.

As seen from this, by using the magnesium oxide powder having the large particle size for the discharge stabilization material particle 4, the sufficient amount of priming particles can remain in the discharge gap for long time.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, a plasma display panel in the present specification is not directly provided to end users, but practically distributed thereto as merchandise after attaching a high-voltage system circuit, a control system circuit, a package, and others. In the present specification, merchandize using the plasma display panel according to the present invention is also included.

### INDUSTRIAL APPLICABILITY

As described above, it is supposed that the present invention is used for a plasma display panel. However, the present invention can be also used for a plasma display tube (PDT) using the same-type technique for light emission of phosphors by plasma discharge, and for merchandise using the plasma display tube.

Also, at present, a discharge stabilization material particle is generally coated on a protective film on a front-surface glass plate of a module on a front-surface glass plate side. However, as long as priming particles are supplied by energization to an X electrode and a Y electrode (these electrodes may be not provided to the module on the front-surface glass plate side), the present invention can be used even when the discharge stabilization material particle is coated on a module on a rear-surface glass plate side.

1. A plasma display panel including a glass plate module comprising: a glass plate; a dielectric layer contacting with the glass plate; and a protective-film layer of protecting the dielectric layer, wherein
magnesium oxide whose BET specific area is 3 m²/mg or smaller is used for a discharge stabilization material particle coated on the protective-film layer.

2. A plasma display panel including a glass plate module comprising: a glass plate; a dielectric layer contacting with the glass plate; and a protective-film layer of protecting the dielectric layer, wherein
magnesium oxide whose impurity content is 20 ppm or lower is used for a discharge stabilization material particle coated on the protective-film layer.

3. The plasma display panel according to claim 2, wherein
the impurity is aluminum.

4. The plasma display panel according to claim 2, wherein
the impurity is iron.

5. The plasma display panel according to claim 2, wherein
the impurity is nickel.

6. The plasma display panel according to claim 2, wherein
the impurity is manganese.

7. The plasma display panel according to claim 2, wherein
the impurity is chromium.

8. A plasma display panel including a glass plate module comprising: a glass plate; a dielectric layer contacting with the glass plate; and a protective-film layer of protecting the dielectric layer, wherein
magnesium oxide containing impurities in which all or a part of aluminum, iron, nickel, manganese, and chromium are mixed is used for the discharge stabilization material particle coated on the protective-film layer, and
each content of the aluminum, the iron, the nickel, the manganese, and the chromium in the magnesium oxide is 20 ppm or lower.

9. The plasma display panel according to claim 2, wherein
magnesium oxide or calcium oxide is used for a material of the protective-film layer.

10. A plasma display device using the plasma display panel according to claim 9.
